(19) United States
(12) Patent Application Publication
(10) Pub. No.: US 2024/0239512 A1
(43) Pub. Date: Jul. 18, 2024

(54) ROTORCRAFT WITH A BLADE TIP ILLUMINATION SYSTEM

(71) Applicant: AIRBUS HELICOPTERS DEUTSCHLAND GMBH, Donauworth (DE)

(72) Inventors: Michael HECKL, Donauworth (DE); Julius VOGL, Gersthofen (DE)

(73) Assignee: AIRBUS HELICOPTERS DEUTSCHLAND GMBH, Donauworth (DE)

(21) Appl. No.: 18/222,558

(22) Filed: Jul. 17, 2023

(30) Foreign Application Priority Data
Aug. 29, 2022 (EP) 22400009.1

(51) Int. Cl. B64D 47/06; B64C 27/46; B64C 27/82; F21K 2/00

(52) U.S. Cl. CPC B64D 47/06; B64C 27/463; B64C 27/82; F21K 2/00; B64C 2027/8281

(57) ABSTRACT

A rotorcraft with a fuselage and a tail boom, comprising: a horizontal stabilizer mounted to the tail boom; rotor blades with rotor blade tips which form a virtual blade tip circle upon rotation around a rotor head; luminescent components provided on the rotor blade tips; and a blade tip illumination device comprising at least one light source integrated into the horizontal stabilizer and configured to emit a light beam toward the virtual blade tip circle for excitation of the luminescent components; wherein the luminescent components emit light in response to excitation via the emitted light beam, and wherein the emitted light forms during rotation of the rotor blade tips around the rotor head on the virtual blade tip circle a luminous ring.

### CROSS-REFERENCE TO RELATED APPLICATIONS

This application claims priority to European patent application No. EP 22400009.1 filed on Aug. 29, 2022, the disclosure of which is incorporated in its entirety by reference herein.

### TECHNICAL FIELD

The disclosure is related to a rotorcraft with a blade tip illumination system.

### BACKGROUND

In various flight missions of rotorcrafts precise and reliable information with respect to distances between the rotorcrafts and respective obstacles is required. For instance, if a rotorcraft such as a helicopter is hovering close to a wind turbine generator, e.g., for hoisting above the nacelle resp. maintenance platform of the wind turbine generator, the pilot of the helicopter must take extreme care that the helicopter is not drifting towards the wind turbine generator structure and/or its wind turbine blades. This also generally applies to any confined area, e.g., close to mountain ridges, trees, etc.

Furthermore, particular flight conditions may also be challenging for pilots. For instance, comparatively slow helicopter side drift due to repetitive side wind gusts may easily go unnoticed by the pilot and result in a stepwise drifting of the helicopter towards the wind turbine generator structure and/or its wind turbine blades. Moreover, in flight conditions with comparatively low visibility, e.g., due to night time, visibility to certain position reference points at the wind turbine generator may also be rather limited.

In the flight missions and flight conditions described above, the pilot may be placed in a position to prevent a potentially disastrous rotor strike of the helicopter's rotor blades against the wind turbine generator structure and/or its wind turbine blades by providing the pilot with precise and reliable information with respect to distances between the helicopter and the wind turbine generator structure and/or its wind turbine blades.

Another problem arises, however, with respect to ground personnel acting on ground around helicopters, e.g., medics in Emergency Medical Service missions. Such ground personnel is endangered and may be harmed by the rotor blades of the helicopter and, more particularly, by respective rotor blade tips as they are rarely visible and distinguishable in night time missions.

The document EP 3 072 813 B1 describes a helicopter comprising a helicopter light system with layer material and light sources. The layer material comprises at least one of a fluorescent material and a phosphorescent material. The light sources comprise any appropriate lighting device, such as a light bulb, LED, or OLED in any appropriate number, which is capable of generating light in appropriate color and of sufficient lighting power to be directed onto the layer material for sufficient light emission and/or reflection by the layer material. More specifically, the helicopter comprises a helicopter body, which includes a main frame and a tail boom. Furthermore, the helicopter comprises multiple rotor blades, each rotor blade having rotor blade tips at both of its ends, wherein layer material of the helicopter light system is arranged at only one rotor tip or at both rotor tips of a given rotor blade. Particularly, the layer material is arranged on a side of the rotor blade tip of the given rotor blade that faces the helicopter body, which side is a bottom side of the given rotor blade. When light from a given light source of the helicopter light system is directed onto the layer material on the given rotor blade, visible light is emitted and/or reflected by the layer material during rotation of the given rotor blade of the helicopter.

However, the helicopter light system uses a plurality of different light sources distributed over the helicopter's fuselage. Accordingly, a complex and cost-intensive blade tip illumination system is provided.

### SUMMARY

It is, therefore, an object of the present disclosure to provide a new rotorcraft with a simplified blade tip illumination system that is suitable to overcome the above-described drawbacks and problems of the state-of-the-art.

More specifically, according to the present disclosure a rotorcraft with a fuselage and a tail boom comprises: a horizontal stabilizer mounted to the tail boom, at least one main rotor, at least one luminescent component, and a blade tip illumination device. The at least one main rotor comprises a rotor head and a plurality of rotor blades extending from the rotor head toward associated rotor blade tips, wherein the associated rotor blade tips form a virtual blade tip circle upon rotation around the rotor head. The at least one luminescent component is provided on at least one of the associated rotor blade tips. The blade tip illumination device comprises at least one light source configured to emit a light beam toward the virtual blade tip circle for excitation of the at least one luminescent component. The at least one luminescent component is adapted to emit light in response to excitation via the emitted light beam, wherein the emitted light forms during rotation of the associated rotor blade tips around the rotor head on the virtual blade tip circle a luminous ring. The at least one light source is integrated into the horizontal stabilizer.

Advantageously, in the inventive rotorcraft the blade tip illumination system with the blade tip illumination device and the at least one luminescent component enables particularly in night time missions, but also in day time missions, a clear indication of the rotor blade tips to a pilot of the rotorcraft, thereby increasing safety of flight and maneuver potential of the rotorcraft. Furthermore, a clear indication of the rotor blade tips may be provided to ground personnel acting on ground around the rotorcraft, thereby increasing safety of the ground personnel and reducing a possible endangerment of the ground personnel. The blade tip illumination system has a simple low-cost configuration and avoids a requirement for expensive additional components.

More specifically, such a low-cost configuration may be obtained by painting conventional standard rotor blades on their rotor blade tips with reflective paintings or coatings. Alternatively, low-cost stickers may be attached to the rotor blade tips. However, application of the reflective paintings or coatings, or stickers, is not limited to the rotor blade tips, but could also be made on the entire rotor blades or on one or more selected sections thereof.

Preferably, the reflective paintings or coatings, or stickers, illuminate the rotor blade tips in response to being charged, i.e., excited with the light beams. Preferentially, the reflective paintings or coatings, or stickers, provide for a so-called “afterglow effect”, i.e., they emit light in rotation of the at least one main rotor not only at the positions where they are charged, i.e., excited with the light beams, but all over the virtual blade tip circle.

By way of example, a reflective painting on the rotor blade tip of a given rotor blade may comprise a base coat that enables application of a paint, a phosphorescent paint applied on the base coat to make the rotor blade tip visible, and a glossy clear coat. The phosphorescent paint may be provided in several colors and can be applied in a suitable thickness according to a respectively desired brightness. The glossy clear coat may be used to make the rotor blade tip visible with a night-vision device. Generally, the reflective painting on the given rotor blade is preferably applied on the rotor blade's lower side (or underside), but application is not limited to the lower side if e.g., visibility on top shall be increased as well.

Furthermore, on the rotorcraft's horizontal stabilizer, which is e.g., provided on the rotorcraft's tail boom, one or more light sources (e.g., white and/or infrared) are installed and their respective light beams are directed towards the rotor blades and, more particularly, to the rotor blade tips. The position of the light sources on the horizontal stabilizer is preferably on the left and right side of the rotorcraft.

Preferably, a light source such as e.g., LED, Halogen, Laser, Xenon, etc. is used which emits white light, but which may also emit some light in infrared spectrum for reflection by the reflective paintings or coatings, or stickers. However, the light source may likewise emit some light in the whole spectrum from ultraviolet to infrared. In other words, the light source may also be an ultraviolet light source.

Preferably, for white light (measured in cd) a white light beam with a luminous intensity of at least 65,000 cd, preferably 68,000 cd, and with a beam angle of less than 10°, preferably 8°, is generated. In other words, a suitable level of lighting power of the light source is required so that the light beam will sufficiently charge the reflective paintings or coatings, or stickers. Preferably, at least in night time missions the reflection of the light beams is visible and may, thus, make the rotor blade tips, i.e., the rotor blades visible to rotorcraft personnel or crew, as well as ground personnel and/or passengers.

If desired, the rotor blade tips, i.e., the rotor blades may be made visible with the blade tip illumination system upon request/need by a pilot of the rotorcraft, e.g., by switching the system manually/automatically on when needed. By charging the reflective paintings or coatings, or stickers by the one or more light sources installed in the non-rotating system of the rotorcraft, there is low dynamic impact, coupled with low costs, low weight impact and easy retrofit installation and compatibility with existing rotorcrafts and systems. The afterglow effect of the reflective paintings or coatings, or stickers ensures proper behavior as the afterglow ensures lighting even after the one or more light sources are shut off, or in case of failure. This is advantageous as e.g., ground personnel acting around a rotorcraft immediately after landing may distinguish the rotor blade tips, i.e., the rotor blades, for a predetermined time once the rotorcraft is shut off.

In an illustrative realization, comparatively powerful light sources generating e.g., white light beams with a luminous intensity of at least 65,000 cd, preferably 68,000 cd, are used as described above and arranged on top of the horizontal stabilizer, but integrated into the horizontal stabilizer, to charge in each luminescent component a respective phosphorescent paint during rotation of the at least one main rotor. Due to the comparatively short distance between the horizontal stabilizer and the virtual blade tip circle of at most 2 m, preferably 1.5 m, as well as an improved illumination angle, i.e., nearly perpendicular to the phosphorescent paint, a suitable charging effect may be obtained. The light sources themselves are preferably suitable to emit comparatively focused light beams with a beam angle of less than 10°, preferably 8°, so that illumination of a few percent (preferably lower than 5%) of the virtual blade tip circle is sufficient. However, due to the comparatively high power, good angle and concentrated light beams, it is still enough to charge the phosphorescent paint itself so high that the full virtual blade tip circle is clearly visible with human eyes, even if more than 90% of the virtual blade tip circle are not illuminated by the light sources at all. In fact, the charging of the phosphorescent paint causes a comparatively high emitting of light by photons, i.e., by the phosphorescent paint itself. The phosphorescent paint itself is preferably just applied on selected areas on the rotor blade tips. No cover is needed to protect the phosphorescent paint and preferably just a glossy clear coat is applied on the phosphorescent paint.

According to some aspects, the horizontal stabilizer forms a wing-like structure with an inner volume, wherein the at least one light source is arranged inside the inner volume.

Preferably, the at least one light source is covered by a transparent cover, wherein the transparent cover is aligned with an upper surface of the horizontal stabilizer.

The emitted light beam may be a white light beam with a luminous intensity of at least 65,000 cd, preferably 68,000 cd, and with a beam angle of less than 10°, preferably 8°.

By way of example, the horizontal stabilizer and the virtual blade tip circle are spaced apart from each other by a predetermined vertical distance of at most 2 m, preferably 1.5 m.

Preferably, the emitted light beam is at least approximately emitted in a direction perpendicular to the horizontal stabilizer.

The emitted light beam may be focused towards the virtual blade tip circle and strikes the at least one luminescent component at least approximately perpendicularly during rotation of the associated rotor blade tips around the rotor head.

The at least one light source may be one of a LED, Halogen, Laser or Xenon light.

According to some aspects, the at least one luminescent component comprises a luminescent sticker attached on the at least one of the associated rotor blade tips, and/or a luminescent coating applied to the at least one of the associated rotor blade tips.

The luminescent coating may comprise at least a base coating, a phosphorescent layer, and a glossy clear coating.

Preferably, the glossy clear coating comprises a glossiness of more than 90 Gloss units.

If desired, the phosphorescent layer is adapted to return light in response to excitation with a white light beam, and the glossy clear coating is adapted to return light in response to excitation with an infrared light beam.

According to some aspects, the rotorcraft further comprises a command unit configured to command the at least one light source to emit one of the white light beam, or the infrared light beam.

If desired, the emitted light may have a wavelength suitable for detection with a night-vision device, if the emitted light beam is the infrared light beam with a radiant intensity of approximately 0.1 W/sr.

a Preferably, the luminous ring disappears within predetermined period of time, preferably within less than 5 minutes, if the at least one light source is switched off.

### BRIEF DESCRIPTION OF THE DRAWINGS

Preferred embodiments of the disclosure are outlined by way of example in the following description with reference to the attached drawings. In these attached drawings, identical or identically functioning components and elements are labeled with identical reference numbers and characters and are, consequently, only described once in the following description.

FIG. 1 shows a lateral view of an illustrative rotorcraft;

FIG. 2 shows a top view of the rotorcraft of FIG. 1 with a blade tip illumination system according to an aspect, with the blade tip illumination system in operation;

FIG. 3 shows a front view of the rotorcraft of FIG. 2 with the blade tip illumination system in operation;

FIG. 4 shows a schematic view of a horizontal stabilizer of the rotorcraft of FIG. 1 to FIG. 3; and

FIG. 5 shows a schematic view of a rotor blade tip with a luminescent component according to an aspect.

### DETAILED DESCRIPTION

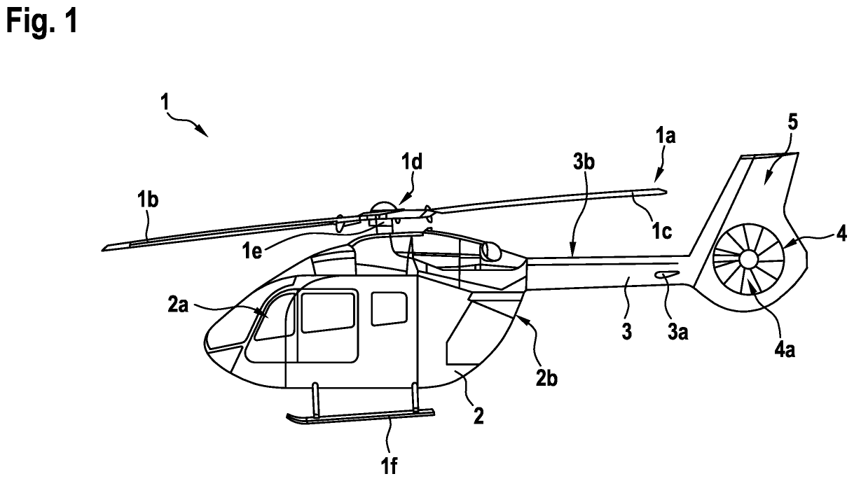

FIG. 1 shows a rotorcraft 1 that is, by way of example, illustrated as a helicopter. Thus, for purposes of simplicity and clarity, the rotorcraft 1 is hereinafter referred to as the “helicopter 1”. The present disclosure is, however, not limited to helicopters and may likewise be applied to any other rotorcraft.

Illustratively, the helicopter 1 comprises at least one main rotor 1a, preferably a multi-blade main rotor, for providing lift and forward or backward thrust during operation. By way of example, the at least one main rotor 1a comprises a plurality of rotor blades which are connected at an associated rotor head 1d to a rotor shaft 1e, which rotates in operation of the helicopter 1 about an associated rotor axis. Two rotor blades of the plurality of rotor blades are visible in FIG. 1 and separately labelled with the reference signs 1b, 1c.

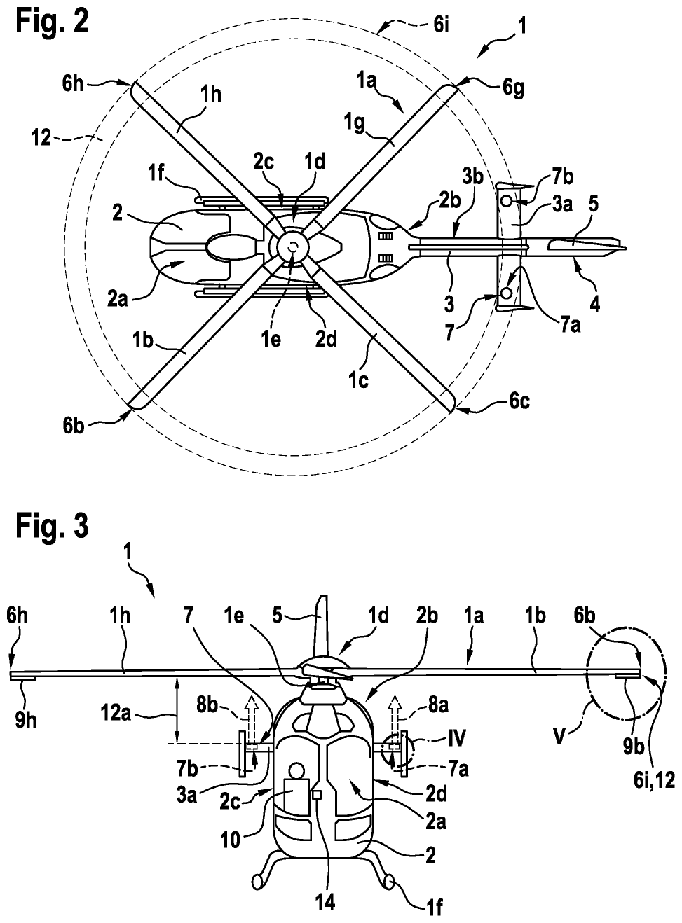

Furthermore, the helicopter 1 comprises a fuselage 2 that preferably forms an aircraft interior region 2a. Illustratively, a left-hand side of the fuselage 2 is shown and, thus, a portside wall (2d in FIG. 2) of the fuselage 2 of the helicopter 1, to which a landing gear 1f of the skid-type is attached, by way of example. The aircraft interior region 2a may accommodate a cockpit and may further accommodate a cabin for passengers and/or cargo.

By way of example, a tail boom 3 with a horizontal stabilizer 3a is connected at a rear fuselage 2b to the fuselage 2 of the helicopter 1. The tail boom 3 is illustratively implemented as a slim beam element that comprises at least a tubular tail boom cone 3b.

The helicopter 1 illustratively further comprises at least one preferentially shrouded counter-torque device 4 configured to provide counter-torque during operation, i.e., to counter the torque created by rotation of the at least one main rotor 1a for purposes of balancing the helicopter 1 in terms of yaw. The at least one counter-torque device 4 is illustratively provided at an aft section of the tail boom 3 and preferably comprises a tail rotor 4a. The aft section of the tail boom 3 preferably further comprises a fin 5.

FIG. 2 shows the helicopter 1 of FIG. 1 seen from above. The helicopter 1 comprises the fuselage 2 that illustratively forms a starboard side wall 2c and a portside wall 2d. The tail boom 3 is connected to the fuselage 2 at the rear fuselage 2b and comprises the horizontal stabilizer 3a, the counter-torque device 4 and the fin 5. The helicopter 1 further comprises the at least one main rotor 1a with the plurality of rotor blades which are connected at the rotor head 1d to the rotor shaft 1e.

The plurality of rotor blades comprises the rotor blades 1b, 1c of FIG. 1, as well as two additional rotor blades 1g, 1h. The plurality of rotor blades 1b, 1c, 1g, 1h extend from the rotor head 1d toward associated rotor blade tips 6b, 6c, 6g, 6h. The rotor blade tips 6b, 6c, 6g, 6h form a virtual blade tip circle 6i upon rotation around the rotor head 1d. The blade tip circle 6i is referred to as being “virtual”, as actually no circle is formed. In fact, the rotor blade tips 6b, 6c, 6g, 6h are merely travelling along a circular path around the rotor head 1d.

In order to enable especially in night time missions, but preferably also in day-time missions, of the helicopter 1 a clear indication of the rotor blade tips 6b, 6c, 6g, 6h to a pilot (10 in FIG. 3) of the helicopter 1, a blade tip illumination system with a blade tip illumination device 7 and at least one luminescent component (9b, 9h in FIG. 3) is provided. The at least one luminescent component is provided on at least one of the rotor blade tips 6b, 6c, 6g, 6h, as described in more detail below at FIG. 3 and FIG. 5.

The blade tip illumination device 7 comprises at least one light source configured to emit a light beam toward the virtual blade tip circle 6i for excitation of the at least one luminescent component. The at least one light source may be one of a LED, Halogen, Laser or Xenon light.

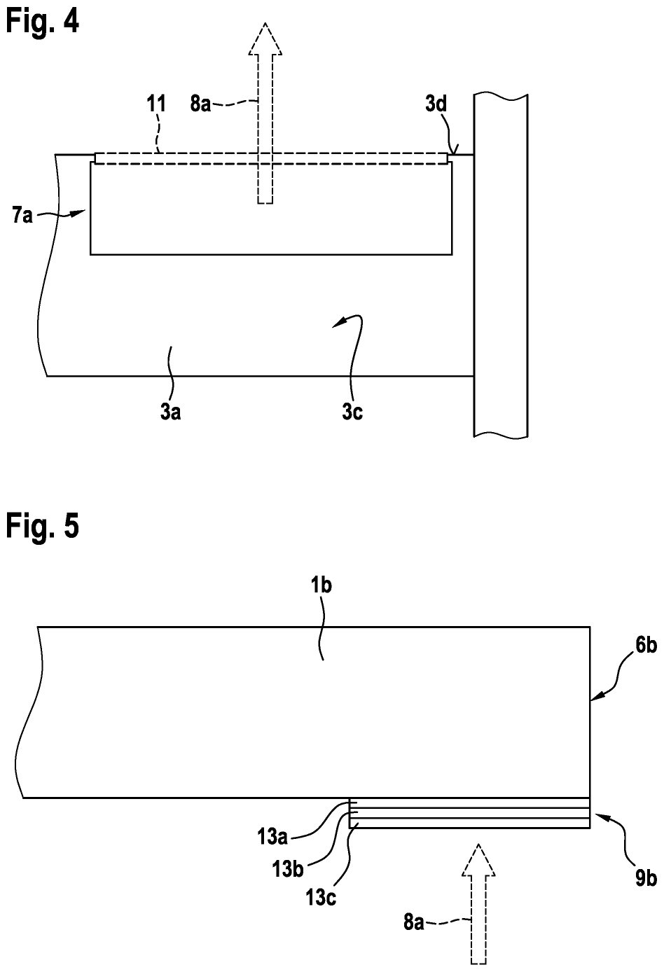

Illustratively, the blade tip illumination device 7 comprises two light sources 7a, 7b, each one being configured to emit an associated light beam (8a, 8b in FIG. 3) toward the virtual blade tip circle 6i for excitation of the at least one luminescent component (9b, 9h in FIG. 3). The two light sources 7a, 7b are integrated into the horizontal stabilizer 3a of the tail boom 3, as explained in detail at FIG. 4. Illustratively, each one of the two light sources 7a, 7b is arranged on, or close to, an outer, i.e., free end of the horizontal stabilizer 3a.

Each luminescent component (9b, 9h in FIG. 3) is adapted to emit light in response to excitation via, i.e., in response to being charged by, the emitted light beams of the two light sources 7a, 7b. The emitted light forms during rotation of the rotor blade tips 6b, 6c, 6g, 6h around the rotor head 1d on the virtual blade tip circle 6i a luminous ring 12. Each luminescent component may comprise a luminescent sticker attached on an associated one of the rotor blade tips 6b, 6c, 6g, 6h, and/or a luminescent coating (13a, 13b, 13c in FIG. 5) applied to the associated one of the rotor blade tips 6b, 6c, 6g, 6h.

FIG. 3 shows the helicopter 1 of FIG. 2 seen from the front. The helicopter 1 comprises the fuselage 2 that forms the aircraft interior region 2a, the starboard side wall 2c, and the portside wall 2d. The helicopter 1 further comprises the at least one main rotor 1a with the plurality of rotor blades, from which only the rotor blades 1b, 1h are visible. The plurality of rotor blades 1b, 1h is connected at the rotor head 1d to the rotor shaft 1e and each one of the rotor blades has an associated rotor blade tip. As only the rotor blades 1b, 1h are visible, likewise only the rotor blade tips 6b, 6h are visible. The rotor blade tips 6b, 6h form the virtual blade tip circle 6i upon rotation around the rotor head 1d. The virtual blade tip circle 6i is preferably spaced apart from the horizontal stabilizer 3a by a predetermined vertical distance 12a of at most 2 m, preferably 1.5 m.

Moreover, the helicopter 1 comprises the blade tip illumination system with the blade tip illumination device 7 having the two light sources 7a, 7b, as well as the at least one luminescent component. The two light sources 7a, 7b are configured to emit associated light beams 8a, 8b. Each one of the emitted light beams 8a, 8b may be a white light beam with a luminous intensity of at least 65,000 cd, preferably 68,000 cd, and with a beam angle of less than 10°, preferably 8°. Illustratively, each one of the emitted light beams 8a, 8b is at least approximately emitted in a direction perpendicular to the horizontal stabilizer 3a. More specifically, the emitted light beams 8a, 8b are preferably focused towards the virtual blade tip circle 6i and strike the at least one luminescent component at least approximately perpendicularly during rotation of the rotor blade tips 6b, 6h around the rotor head 1d.

Preferably, each one of the rotor blade tips is provided with an associated luminescent component. Illustratively, the rotor blade tip 6b is provided with a luminescent component 9b, and the rotor blade tip 6h is provided with a luminescent component 9h. Preferably, the luminescent components 9b, 9h are arranged on a lower side, i.e., an underside of the rotor blade tips 6b, 6h.

In operation of the helicopter 1, the rotor blades 1b, 1h and, thus, the rotor blade tips 6b, 6h rotate around the rotor head 1d and form the virtual blade tip circle 6i. Thereby, the luminescent components 9b, 9h provided on the rotor blade tips 6b, 6h may be excited, i.e., charged by the light beams 8a, 8b emitted from the light sources 7a, 7b which are integrated into the horizontal stabilizer 3a. The luminescent components 9b, 9h preferably emit light in response to excitation via the emitted light beams 8a, 8b of the two light sources 7a, 7b and the emitted light forms during rotation of the rotor blade tips 6b, 6h around the rotor head 1d on the virtual blade tip circle 6i the luminous ring 12. The luminous ring 12 is preferably visible from the aircraft interior region 2a, e.g., at least from a pilot 10 in the cockpit of the helicopter 1, but preferentially also e.g., from ground personnel acting during or after landing and/or before or during take-off around the helicopter 1 on ground. The luminous ring 12 preferably disappears within a predetermined period of time, preferentially within less than 5 minutes, if the light sources 7a, 7b are switched off. In other words, the luminescent components 9b, 9h provide for a so-called “afterglow effect”, i.e., they emit light in rotation of rotor blades 1b, 1h and, thus, the rotor blade tips 6b, 6h around the rotor head 1d not only at the positions where they are charged, i.e., excited with the light beams 8a, 8b, but all over the virtual blade tip circle 6i.

If desired, the light sources 7a, 7b may be switched between emission of the white light beams 8a, 8b with the luminous intensities described above, and emission of infrared light beams, e.g., by means of a command unit 14 configured to command the light sources 7a, 7b to emit either the white light beams or the infrared light beams. If the light beams 8a, 8b are the infrared light beams, e.g., with a radiant intensity of approximately 0.1 W/sr, the emitted light from the luminescent components 9b, 9h may have a wavelength suitable for detection with a night-vision device. The wavelength suitable for detection by a night-vision device is preferably comprised in a wavelength spectrum ranging from 450 nm to 930 nm, preferentially from 650 nm to 850 nm.

FIG. 4 shows the horizontal stabilizer 3a of the helicopter 1 of FIG. 1 to FIG. 3, with the light source 7a of the blade tip illumination device 7 of FIG. 1 to FIG. 3. By way of example, the outer end, i.e., free end of the horizontal stabilizer 3a on the left-hand side of the helicopter 1 of FIG. 1 to FIG. 3, i.e., on the side of the portside wall 2d of FIG. 2 and FIG. 3, is shown.

Illustratively, the horizontal stabilizer 3a forms a wing-like structure with an inner volume 3c and an upper surface 3d. The upper surface 3d is arranged on an upper side of the horizontal stabilizer 3a and, thus, faces the plurality of rotor blades 1b, 1c, 1g, 1h of FIG. 2, i.e., the virtual blade tip circle 6i of FIG. 2.

The light source 7a that emits the light beam 8a is integrated into the horizontal stabilizer 3a and, preferably, arranged inside the inner volume 3c. Furthermore, the light source 7a may be covered by a transparent cover 11. The transparent cover 11, in turn, may be aligned with the upper surface 3d of the horizontal stabilizer 3a. Thus, an aerodynamically improved arrangement of the light source 7a in the horizontal stabilizer 3a may be achieved.

It should be noted that integration of the light source 7b of FIG. 2 and FIG. 3 into the horizontal stabilizer 3a on the right-hand side of the helicopter 1 of FIG. 1 to FIG. 3, i.e., on the side of the starboard side wall 2c of FIG. 2 and FIG. 3, is preferably similar. Thus, a more detailed description thereof may be omitted, for brevity and conciseness.

FIG. 5 shows the rotor blade tip 6b of the rotor blade 1b of FIG. 2 and FIG. 3, which is provided with the luminescent component 9b as described above at FIG. 3. The luminescent component 9b may comprise a luminescent sticker attached on the rotor blade tip 6b, and/or a luminescent coating applied to the rotor blade tip 6b.

By way of example, the luminescent component 9b is formed as a luminescent coating. Preferably, the luminescent coating comprises at least a base coating 13a and a phosphorescent layer 13b. The phosphorescent layer 13b may be adapted to emit light at least in response to being excited with a white light beam, i.e., with the light beams 8a, 8b of FIG. 3.

The luminescent coating may further comprise a glossy clear coating 13c. The glossy clear coating 13c may at least be adapted to return light in response to being excited with an infrared light beam and may be formed with a glossiness of more than 90 Gloss units.

Finally, it should be noted that modifications to the above-described embodiments are within the common knowledge of the person skilled in the art and, thus, also considered as being part of the present disclosure. For instance, FIG. 2, FIG. 3, and FIG. 5 make only reference to luminescent components provided on rotor blade tips. However, one or more rotor blades may also be provided with more than one luminescent component. For instance, a given rotor blade may be provided with a plurality of luminescent components which are spaced apart from each other on the given rotor blade, and so on.

### REFERENCE LIST

1 rotorcraft
1a multi-blade main rotor
1b, 1c, 1g, 1h rotor blades
1d rotor head
1e rotor shaft
1f landing gear
2 fuselage
2a cockpit
2b rear fuselage
2c starboard side wall
2d port side wall
3 tail boom
3a horizontal stabilizer
3b tail boom cone
3c horizontal stabilizer inner volume
3d horizontal stabilizer upper surface
4 counter-torque device
4a tail rotor
5 fin
6b, 6c, 6g, 6h rotor blade tips
6i virtual blade tip circle
7 blade tip illumination device
7a, 7b light sources
8a, 8b light beams
9b, 9h luminescent components
10 rotorcraft pilot
11 transparent cover
12 luminous ring
12a vertical distance between horizontal stabilizer and virtual blade tip circle
13a base coating
13b phosphorescent layer
13c clear coating
14 command unit

What is claimed is:

1. A rotorcraft with a fuselage and a tail boom, comprising:
a horizontal stabilizer mounted to the tail boom;
at least one main rotor with a rotor head and a plurality of rotor blades extending from the rotor head toward associated rotor blade tips, wherein the associated rotor blade tips form a virtual blade tip circle upon rotation around the rotor head;
at least one luminescent component provided on at least one of the associated rotor blade tips; and
a blade tip illumination device comprising at least one light source configured to emit a light beam toward the virtual blade tip circle for excitation of the at least one luminescent component;
wherein the at least one luminescent component is adapted to emit light in response to excitation via the emitted light beam, wherein the emitted light forms during rotation of the associated rotor blade tips around the rotor head on the virtual blade tip circle a luminous ring, and wherein the at least one light source is integrated into the horizontal stabilizer.

2. The rotorcraft of claim 1,
wherein the horizontal stabilizer forms a wing-like structure with an inner volume, and wherein the at least one light source is arranged inside the inner volume.

3. The rotorcraft of claim 1,
wherein the at least one light source is covered by a transparent cover, and wherein the transparent cover is aligned with an upper surface of the horizontal stabilizer.

4. The rotorcraft of claim 1,
wherein the emitted light beam is a white light beam with a luminous intensity of at least 65,000 cd, preferably 68,000 cd, and with a beam angle of less than 10°, preferably 8°.

5. The rotorcraft of claim 1,
wherein the horizontal stabilizer and the virtual blade tip circle are spaced apart from each other by a predetermined vertical distance of at most 2 m, preferably 1.5 m.

6. The rotorcraft of claim 1,
wherein the emitted light beam is at least approximately emitted in a direction perpendicular to the horizontal stabilizer.

7. The rotorcraft of claim 1,
wherein the emitted light beam is focused towards the virtual blade tip circle and strikes the at least one luminescent component at least approximately perpendicularly during rotation of the associated rotor blade tips around the rotor head.

8. The rotorcraft of claim 1,
wherein the at least one light source is one of a LED, Halogen, Laser or Xenon light.

9. The rotorcraft of claim 1,
wherein the at least one luminescent component comprises a luminescent sticker attached on the at least one of the associated rotor blade tips, and/or a luminescent coating applied to the at least one of the associated rotor blade tips.

10. The rotorcraft of claim 9,
wherein the luminescent coating comprises at least a base coating, a phosphorescent layer, and a glossy clear coating.

11. The rotorcraft claim 10,
wherein the glossy clear coating comprises a glossiness of more than 90 Gloss units.

12. The rotorcraft of claim 10,
wherein the phosphorescent layer is adapted to return light in response to excitation with a white light beam, and wherein the glossy clear coating is adapted to return light in response to excitation with an infrared light beam.

13. The rotorcraft of claim 12,
further comprising a command unit configured to command the at least one light source to emit one of the white light beam, or the infrared light beam.

14. The rotorcraft of claim 12,
wherein the emitted light has a wavelength suitable for detection with a night-vision device, if the emitted light beam is the infrared light beam with a radiant intensity of approximately 0.1 W/sr.

15. The rotorcraft of claim 1,
wherein the luminous ring disappears within a predetermined period of time, preferably within less than minutes, if the at least one light source is switched off.
